(19) United States
(12) Patent Application Publication
(10) Pub. No.: US 2026/0138104 A1
(43) Pub. Date: May 21, 2026

(54) MODULAR MULTIPLE NOZZLE SYSTEM WITH INTERCHANGEABLE HUB-CHIP CONFIGURATION FOR PRODUCTION OF MULTI-LAYER DROPLETS AND FIBERS AND METHOD THEREFOR

(71) Applicant: Lawrence Livermore National Security, LLC, Livermore, CA (US)

(72) Inventors: Congwang YE, Livermore, CA (US); William SMITH, Oakland, CA (US); Michael Gregory TRIPLETT, Pleasanton, CA (US)

(73) Assignee: Lawrence Livermore National Security, LLC, Livermore, CA (US)

(21) Appl. No.: 18/950,903

(22) Filed: Nov. 18, 2024

(51) Int. Cl. B01F 25/72; B01F 23/41; B01F 35/30

(52) U.S. Cl. CPC B01F 25/72; B01F 23/41; B01F 2035/351

(57) ABSTRACT

The present disclosure relates to a modular, multi-fluidic, multi-nozzle system. The system may incorporate a hub having a first and second internal fluid reservoirs for holding first and second fluids. The hub has recess in flow communication with each of the first and second internal fluid reservoirs. A fluid droplet generation chip is removably secured in the recess and has first and second flow paths in communication with the first and second internal fluid reservoirs, and an opening forming an ejection port. The fluid droplet generation chip receives streams of the first and second fluids and releases the two streams simultaneously through the ejection port. In this manner double emulsion fluid droplets are created in which a quantity of the first fluid is fully encapsulated within a quantity of the second fluid.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to microfluid flow nozzles, and more particularly to a modular, multiple nozzle system for producing parallel streams of double emulsion droplets or streams in which one fluid fully encases or encapsulates the other.

### BACKGROUND

The statements in this section merely provide background information related to the present disclosure and may not constitute prior art.

The interest in microfluidic droplet creating devices for use in additive manufacturing systems is growing. One example of a parallelizable microfluidic dropmaker with multilayer geometry for the generation of double emulsions is disclosed at DOI: 10.1039/C9LC00966C. Another example of a system and method relating to a dropmaker is “Fabricating structured particles through rapid hardening and tailored collection methods”, described in US 20190291067A1. Still another example is “Microparticles” disclosed in US 20020054912A1. Still another example of a system and method relating to a dropmaker is disclosed in Generation of Steady Liquid Microthreads and Micron-Sized in Gas Monodisperse Sprays Streams “, https://doi.org/10.1103/PhysRevLett.80.285). Still another example is described of a parallelized multiple nozzle system and method to produce layered droplets and fibers for microencapsulation” is disclosed in U.S. Pat. No. 10,351,514 B2, for “Parallelizable microfluidic dropmakers with multilayer geometry for the generation of double emulsions”. This reference describes a technique to use parallelized microfluidic channels for creation of multiple droplet streams, all in an enclosed microfluidic device. US20190291067A1 describes an instrument to create droplets in mid air and cure the polymer with a UV source from the side. US 20020054912A1 describes a method whereby monodispered particles can be made by applying vibration to a liquid stream coming out of a nozzle. “Generation of Steady Liquid Microthreads and Micron-Sized Monodisperse Sprays in Gas Streams” described a technique to form microdroplets using a pressured air stream. U.S. Pat. No. 10,351,514 B2 describes an instrument to create multiple streams of droplets with connected droplet generating devices.

In spite of the advancements described and illustrated in the foregoing documents, there remains a need for a system and method for generating parallel streams of multi-layer droplets, which is able to be constructed in a highly cost effective manner, for example in part or in whole by conventional chip manufacturing techniques, or in part or in whole by an additive manufacturing process, and which also provides virtually unlimited scalability using either conventional or additive manufacturing techniques.

### SUMMARY

This section provides a general summary of the disclosure, and is not a comprehensive disclosure of its full scope or all of its features.

In one aspect the present disclosure relates to a modular multi-fluidic, multi-nozzle system. The system comprises a hub having a first internal fluid reservoir for holding a first fluid, and a second internal fluid reservoir for holding a second fluid, a recess in flow communication with each of the first and second internal fluid reservoirs. The system also includes a fluid droplet generation chip removably secured in the recess and including first and second flow paths in communication with the first and second internal fluid reservoirs, and an opening forming an ejection port. The system further includes the fluid droplet generation chip configured to receive a stream of the first fluid and a stream of the second fluid, and to release the two streams simultaneously through the ejection port. The two streams are released in a manner which produces double emulsion fluid droplets to be created in which a quantity of the first fluid is fully encapsulated within a quantity of the second fluid.

In another aspect the present disclosure relates to a modular, multi-fluidic, multi-nozzle system. The system also comprises a hub having a first port for admitting a first fluid from a first external fluid source into the hub, and a second port for admitting a second fluid from a second external fluid source into the hub. A first internal fluid reservoir communicates with the first port for receiving and holding a first quantity of the first fluid, and a second internal fluid reservoir is included which is in communication with the second port for receiving and holding a first quantity of the second fluid. A plurality of recesses are arranged radially about an axial center of the circular hub, and in flow communication with each of the first and second internal fluid reservoirs. The system also includes a plurality of fluid droplet generation chips each being removably secured in the recess, and each including first and second flow paths in communication with the first and second internal fluid reservoirs, and each having an opening at a lower end thereof forming an ejection port. The fluid droplet generation chips are configured to receive a stream of the first fluid and a stream of the second fluid, and to release the two streams simultaneously through the ejection port. The two streams are released in a manner which creates emulsion fluid droplets in which a second quantity of the first fluid is fully encapsulated within a second quantity of the second fluid.

In still another aspect the present disclosure relates to a method for generating double emulsion droplets. The method comprises providing a hub, using a first port formed on the hub for admitting a first fluid from a first external fluid source into the hub, and using a second port formed on the circular hub for admitting a second fluid from a second external fluid source into the hub. The method further includes using a first internal fluid reservoir within the hub and in communication with the first port for receiving and holding a first quantity of the first fluid, using a second internal fluid reservoir within the hub and in communication with the second port for receiving and holding a first quantity of the second fluid. The method further includes using a plurality of recesses arranged radially about an axial center of the circular hub, and in flow communication with each of the first and second internal fluid reservoirs, to receive a corresponding plurality of fluid droplet generation chips. Each said fluid droplet generating chip is removably secured in the recess, and each chip includes first and second flow paths in communication with the first and second internal fluid reservoirs. Each chip also has an opening at a lower end thereof forming an ejection port. The method also includes using the fluid droplet generation chips to each receive a stream of the first fluid and a stream of the second fluid, and to release the two streams simultaneously through the ejection port in a manner by which a simultaneous parallel plurality of double emulsion fluid droplet streams are created. The double emulsion fluid droplet streams are created having a second quantity of the first fluid fully encapsulated within a second quantity of the second fluid to form each said double emulsion droplet.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a perspective view of one embodiment of a multi-fluidic, modular nozzle system in accordance with the present disclosure;

FIG. 2 is a perspective view of just the hub of the system with the chips removed;

FIG. 3 is a perspective cross sectional illustration of just the hub taken in accordance with section line 3-3 in FIG. 2;

FIG. 4 is a perspective illustration of the system with the chips positioned above their respective recesses just prior to insertion in the recesses, and with an optional lower plate which may be included to further help control stream or droplet formation;

FIG. 5 is a perspective cross-sectional illustration of the system of FIG. 4 taken in accordance with section line 5-5 in FIG. 4;

FIG. 6 shows an isometric illustration of how the two fluids contained in the hub communicate with each of the chips, and in particular how the first fluid (i.e., core fluid) communicates with each chip;

FIG. 7 shows an isometric illustration similar to FIG. 6 but illustrating how the second fluid (i.e., the shell fluid) communicates with each of the chips;

FIG. 8 shows an exploded perspective illustration of another embodiment of the chip in which the chip is formed using a layered, multi-panel construction;

FIG. 9 shows an exploded perspective view of another embodiment of the chip which in which the chip is formed as a multi-panel component with both of the fluid inlet ports in the center panel, and is suitable for being constructed using a hot embossing operation;

FIG. 10 shows the chip of FIG. 9 after being constructed using a hot embossing operation;

FIG. 11 shows another embodiment of the system in which the hub is formed as a multi-component assembly;

FIG. 12 shows an exploded perspective illustration of the separate components used to form the hub of FIG. 11.

### DETAILED DESCRIPTION

Example embodiments will now be described more fully with reference to the accompanying drawings.

The present disclosure describes various embodiments of a system representing a multiple nozzle microfluidic unit that enables simultaneous generation of a plurality of streams of coaxial liquid jets, with each stream having multiple fluid layers. Liquids may be pumped into the device at a combined, widely varying flow rate, in some embodiments from 100 ml/hr to 10 L/hr. In some embodiments droplets are created in the range of 1 μm to 5 mm and can be created with one or more shell layers of fluid. Liquid used in the device can have widely varying viscosities, in some embodiments up to 500,000 cps based on the need. In some embodiments the device has a central hub unit that takes liquid coming from connected fluid dispensing devices and distributes the liquid into radially arranged droplet generation chips around it. Each droplet generation chip has microfluidic pathways that can create highly tailored, consistent liquid streams in each device. Droplets created from the system can optionally be UV treated and/or heat treated to turn the droplets into hard/soft capsules and particles, or optionally used “as is”. By changing fluid flow rates, rheological properties, and liquid pinching parameters, the system can also be used to produce fibers with multiple sheath layers. Depending on the application, materials created using the system can be used for a wide variety of diverse applications, for example and without limitation, energy, bio, pharmaceutical, food, cosmetic and other applications.

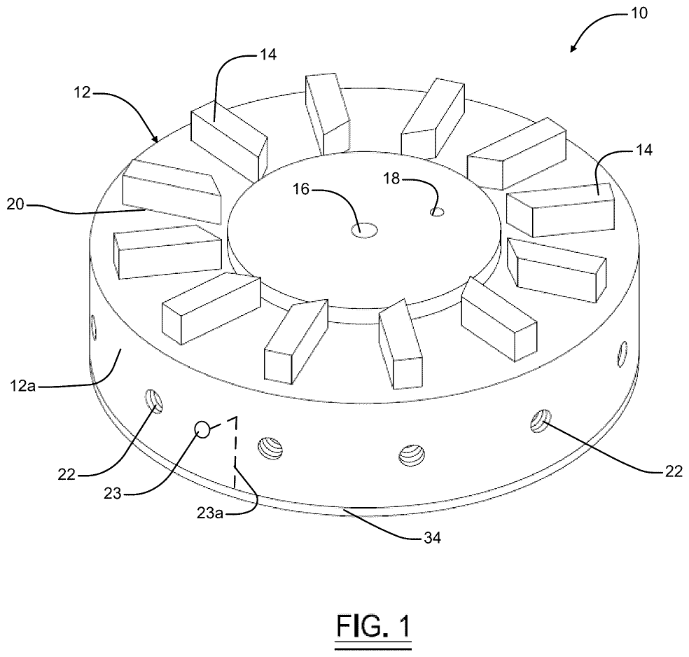

Referring to FIG. 1, one embodiment of a system 10 forming a microfluidic unit will be described. In this example the system includes a single piece hub unit 12 (hereinafter simply “hub 12”) and a plurality of drop generation chips 14 (hereinafter simply “chips 14”) arranged equidistantly radially relative to the axial center of the hub. A first port 16 at the axial center off the hub 12 may be coupled to a first fluid source, for example a syringe filled with fluid, a tube coupled to a fluid source/reservoir, etc. First port 16 allows a first fluid to be admitting to the interior area of the hub 12 and helps to channel fluid within the hub to the chips 14. A second port 18 offset from the axial center of the hub 12 and enables a second fluid to be admitted into an interior area of the hub and channeled independently of the first fluid within the hub to each of the chips 14. The chips 14 in this example are shaped to be inserted into like-shaped recesses 20 in the hub 12. Threaded bores 22 arranged circumferentially around a sidewall 12a of the hub 12, and aligned with respective ones of the recesses 22, may be used to receive threaded set screws 24. The threaded set screws 24 engage sidewall portions of the chips 14 when the chips are fully inserted in their respective recesses 20 and help hold the chips securely within the hub 12, and in alignment and tightly engaged with the internal fluid pathways channeling the first and second fluids. Alternatively, a different method of securing the chips 14 can be a spring-driven locking mechanism or similar type of mechanical lock or flexure component/assembly. For example, one could also potentially have a O-ring-like locking ring that slides down (for example along two or more guiding slots) the circumference of the hub 12 to lock everything in one single step. The hub 12 in some embodiments may be formed using a suitable additive manufacturing process as a single piece component.

It will be appreciated that while the chips 14 and recesses 20 are shown in the Figures as having a common trapezoidal shape, that the chips 14 and recesses 20 could be other shapes, for example and without limitation, square, rectangular, triangular, etc. The trapezoidal shape provides the advantage of “keying” the chips 14 to the recesses 20, or in other words providing a shape that allows the chips 14 to be inserted only in one specific orientation in the recesses 20. If other shapes besides a trapezoid are employed, for example a square or rectangular shape, then one may form both the chips 14 and the recesses 20 with locating features (e.g., a rib on one surface of the chip 14 and a groove on one facing surface of the recess 20) so that the chips 14 will still only be insertable in one orientation in the recesses 20.

Also, while the chips 14 have been shown in the illustrations as planar components, it will be appreciated that they need not necessarily be planar. For example, curved or angular cross-sectional shapes could be employed as well. Virtually any shape that allows the chips 14 to be inserted in the recesses 20 may be employed, and which will enable the creation of single or double layer droplet/streams is contemplated by the present disclosure. Furthermore, it is expected that in many instances it may be preferable to use one or more gaskets (not shown) to help seal the interfaces where the chips 14 receive fluids from the hub 12.

With further reference to FIG. 1, in some embodiments the hub 12 may also be provided with a lower plate 34 having a plurality of apertures (not visible in FIG. 1) for helping to form double emulsion droplets. If the lower plate 34 is included, it may be secured to the hub 12 by any suitable, conventional means, such as by, and without limitation, adhesives, a magnetic coupling if the hub 12 and lower plate 34 are made of metal, possibly brazing/welding if the two components 12 and 34 are made of metal, threaded screws, etc. If the lower plate 34 is incorporated, then an air inlet port 23 for receiving pressurized air from an external (i.e., remote) air pressure source may also be used. The air inlet 23 may communication with an internal airflow path 23a formed within the hub 12 which opens on a lower surface 12a1 of the hub. The pressurized air may be tailored to help shear a liquid stream being released from each chip 14 to create droplets of desired sizes. If the lower plate 34 is relatively thin and might tend to flex or bow out slightly from the air pressure used, then one or more spacers may be used within the perimeter of the lower plate 34 to even better help secure the full area of the lower plate 34 to the lower surface 12a1 of the hub 12.

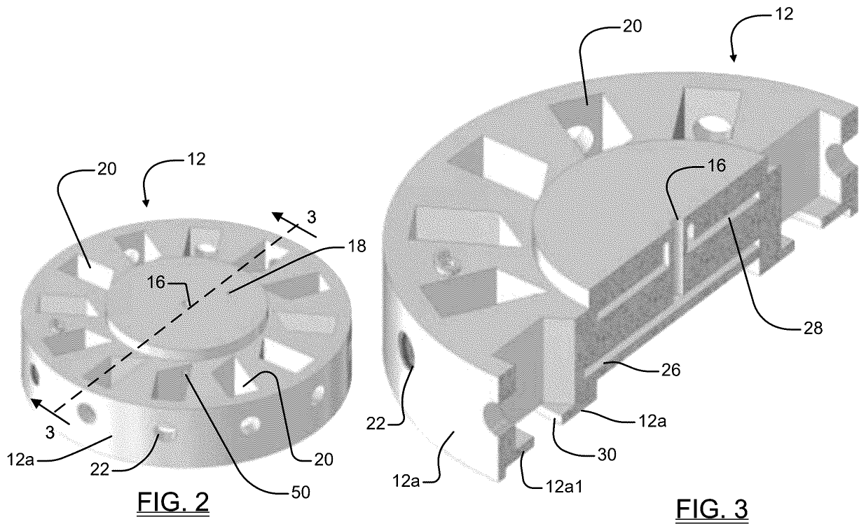

Referring to FIGS. 2 and 3, the internal construction of the hub 12 in this example can be seen more clearly. In this example the hub 12 is shown in FIG. 2 without the chips 14 to better illustrate the recesses 20. The recesses 20 are arranged equidistantly about the circumference of the hub 12, but they need not be, but could rather be at non-equidistant spacings to meet the needs of a particular application. In this example the hub 12 is also of a single piece construction, although a multi-piece construction is also contemplated, as will be discussed in the following paragraphs. FIG. 3 shows that the first fluid port 16 is in communication with a first internal reservoir 26 which is in turn in flow communication with each of the radially arranged chips 14. The second port fluid port 18 is in communication with a second internal fluid reservoir center 28, which is disposed elevationally above the first internal fluid reservoir 26, and which is in turn in fluid communication with each of the chips 14. The chips 14 are constructed to release streams of fluids received from the first and second internal reservoirs 26 and 28, respectively, from the lower sides of the chips. In some embodiments the streams may break into double emulsion droplets of fluid from the lower sides of the chips 14, which are exposed due to openings 30 in a lower surface 12a1 of the hub 12, as shown in FIG. 3.

With the hub 12 design shown in FIGS. 1-3, two fluids, one typically for a core, and one typically for a shell, can flow into the hub 12. The separate fluid reservoirs 26 and 28 inside the hub 12 allow the two fluids to remain separated until they merge into the chips 14. In the case of creating core-shell droplets (i.e., double emulsions), the top flat fluid reservoir space 28 contains the second or “shell” fluid, while the bottom flat chamber space contains the first or “core” fluid. These fluids can be any combination depending on the application. When creating core-shell droplets, the fluids are immiscible. However, the fluids can even be miscible if desired. The two fluids will mix in the chips 14, and when ejected from openings (i.e., ejection ports) at the lower sides of the chips 14, will produce either streams or double emulsions, depending on the configuration and dimensions of the openings/ejection ports. By “double emulsions” it is meant droplets where the first fluid forms the core of the droplet and is fully encased with the second fluid. If a stream is produced, the fluid from the first internal reservoir 26 will be fully encased within fluid from the second internal reservoir 28.

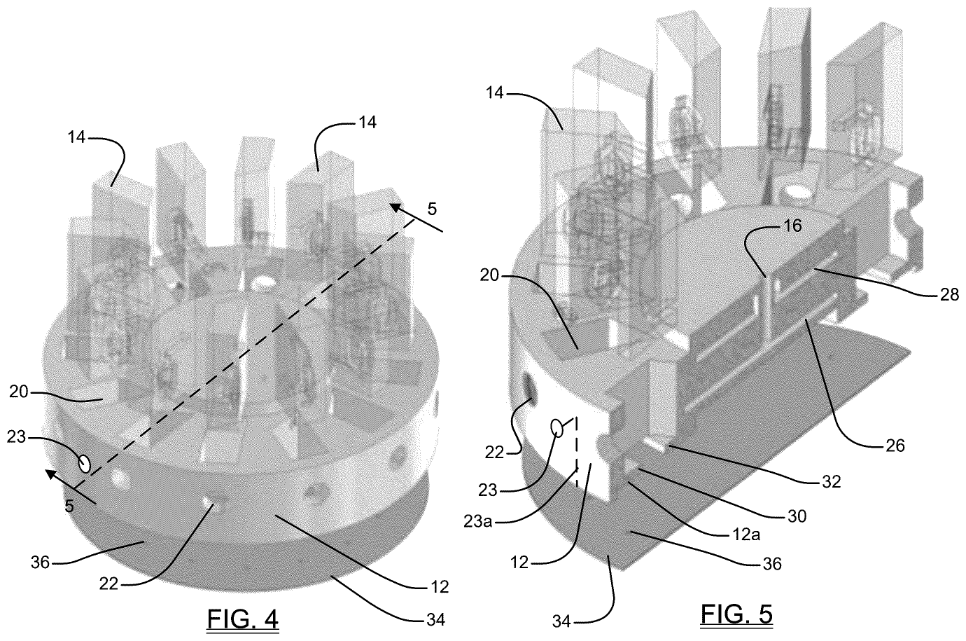

FIGS. 4 and 5 also show the optional lower plate 34 that may be secured against the lower surface 12a1 of the hub 12. The lower plate 34 has a plurality of precisely sized and shaped apertures 36 spaced therearound which align with respective ones of the chips 14. In this manner when the first and second fluids are combined within the chips 14, each chip can release either a stream or a double emulsion through its respective aperture 36. The apertures 36 in this example thus help form either a stream or double emulsions from the two fluid streams released from each chip 14, depending on the dimensions of the apertures. In this manner the lower plate 34 and the apertures 36 can further help to tailor the dimensions of the streams or double emulsions. However, it will be appreciated that the lower plate is optional, the depending on the construction of the chips 14, may not be needed in all applications. Furthermore, it will be appreciated that droplets and liquid streams could still be produced/released and form product even without pressurized air shearing with lower plate 34 in place. Still further each chip 14 could be designed to contain the air shearing path as well. Thus, a three layer chip 14 design with air-polymer-core may be constructed, although such a construction will be more complicated.

When attaching the lower plate 34, it is expected that an alignment feature, for example a raised tab or rib on the lower plate 34, along with a precisely located groove in the lower surface 12a of the hub 12, will be helpful. Such structure would ensure a precise alignment of the apertures 36 with the lower openings 30 in the hub 12, and also with the chips 14, when the lower plate 34 is secured to the hub 12. In some embodiments it is expected that the dimensions of the apertures are likely to be in the range of 10 μm to 10000 μm, but this range may vary widely depending the size of the droplets that need to be produced and possibly other factors, such as, without limitation, the viscosity of the fluids being used and/or the air pressure being applied to the hub 12.

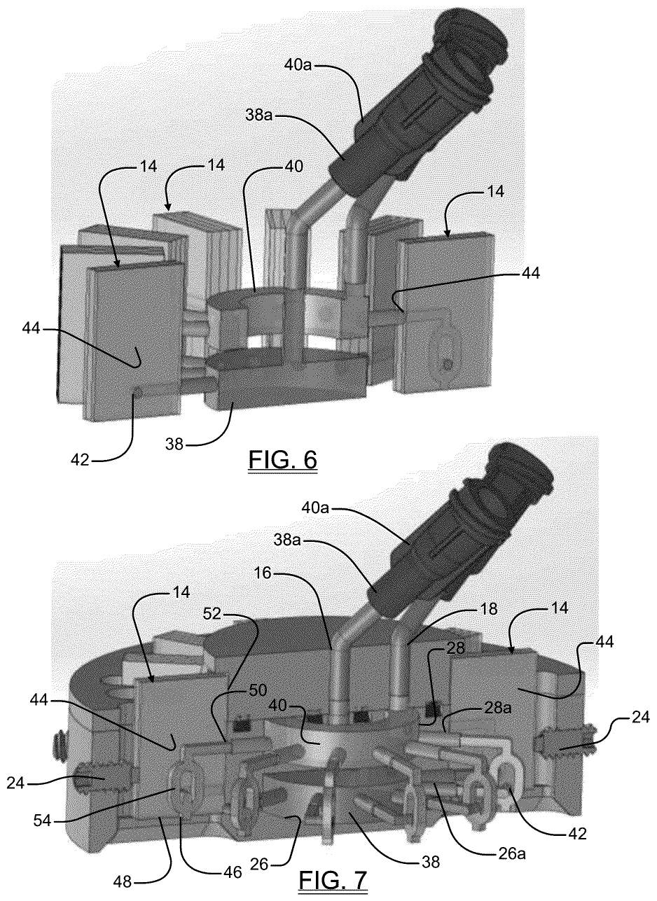

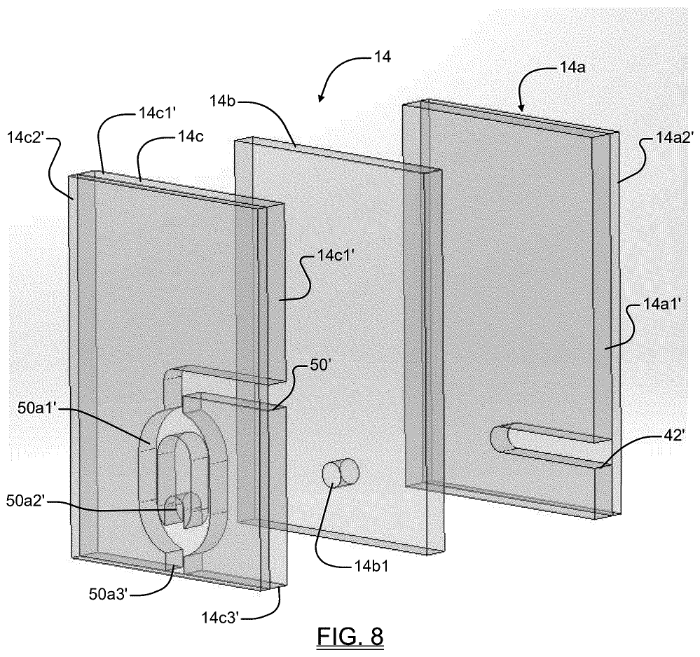

Referring to FIGS. 6 and 7, the construction of the chips 14 can be seen in greater detail along with a representation of the flow paths of the first and second fluids. The first fluid is labelled with reference number 38 and the second fluid is labelled with reference number 40. The fluids 38 and 40 can be introduced through syringes or through fittings 38a and 40a coupled to suitable conduits (not shown) in communication with separate reservoirs of the fluids 38 and 40 (also not shown). The first fluid 38 enters the chip 14 in the same manor as the second fluid (i.e., there are 2 holes on a vertical edge wall 52, with one hole leading to bore 50 which runs through the chip 14 as described and the other extending within the interior of the chip until it reaches bore 42). Bore 42 is where the first fluid enters the flow path of the second fluid 40. Bore 42 is fully encased within the chip 14 and at no point pierces the sidewall of the chip 14. Bore 42 as identified in FIG. 6 is the same as bore 14b1 in FIG. 8. Note that 14b1 is capped off by capping plate 14c2′ and 14a2′ and does not extend to the outside of the chip. 14b1 only opens a fluidic path between fluidic inlet 42′ and fluidic inlet 50a2′. However, it will be appreciated that the fluid inlet ports 38 and 40 do not necessarily need to be on the vertical edge of the chip 14 (though this is certainly convenient for manufacturing). For example, a fluidic port could be introduced via the sidewall of the chip if needed.

With further reference to FIGS. 6 and 7, the first fluid 38 flows from the first reservoir 26 through a radially extending fluid passageway 26a into a bore 42 formed in a major sidewall portion 44 of each chip 14, and extending fully through a thickness of the chip. The first fluid 38 also communicates with a lower opening 46 forming an ejection port, which is formed on a bottom edge wall 48 of each chip 14. In this manner a controlled quantity of the first fluid 38 can be released from the first reservoir 26 into the lower opening 46.

With further reference to FIGS. 6 and 7, the second fluid 40 flows out from the second fluid reservoir 28 through a radially extending fluid passageway 28a and enters into the bore 50 formed in the vertical edge wall 52 of the chip 14. The bore 50 extends within the interior of the chip 14 and forms a “O-shaped” internal flow path that loops around the bore 42, and then terminates in communication with the lower opening 46. As the second fluid 40 flows into and through the chip 14, it is eventually released through the lower opening 46 and fully encapsulates the first fluid 38. As the two fluids 38 and 40 exit the lower opening 46, either a stream or double emulsions are thus formed in which the second fluid 40 fully encapsulates the first fluid 38. In one implementation the two fluids 38 and 40 are immiscible. In other implementations the two fluids 38 and 40 may be miscible. In addition, the fluid passageways 26a and 28a may be treated with surface coatings that provide desired hydrophilic or hydrophobic qualities.

With brief reference to FIG. 8, the chip 14 is shown in greater detail. In this design a multi-layer (or multi-panel) construction of the chip 14 is used to provide three distinct planar panels 14a, 14b and 14c which form the chip 14 when the three panels are fully secured together, such as by adhesives or any other suitable means (e.g., but not limited to, solvent welding, thermal bonding and plasma bonding). In this a fluid inlet 42′ is provided for the first fluid 38 on a sidewall edge of outer panel 14a1′. Outer panel 14a1′ is secured to panel 14a2′ in any suitable manner, in one example by adhesives, which helps form the fluid inlet 42′. The first fluid inlet 42′ communicates with a through bore 14b1 provided on central panel 14b. The through bore 14b1 communicates with the outer panel 14c. Outer panel 14c includes a panel portion 14c1′ which includes a fluid inlet 50′ formed on a vertical sidewall edge thereof which communicates with an O-shaped flow path 50a1′. A solid wall portion 14c2′ helps to close off the O-shaped flow path 50a1′ and to form the fluid inlet 50′. The O-shaped flow path 50a1′ terminates in a fluid exit port 50a3′ formed in a bottom edge wall 14c3′ of the outer panel 14c. Panel portion 14c1′ may be secured to panel portion 14c2′ by any suitable means, for example and without limitation by adhesives, solvent welding, thermal bonding and plasma bonding. This construction provides the advantage of arranging both of the fluid inlets 42′ and 50′ along the common vertical edge of the chip 14. In some applications this arrangement may provide an even more robust fluid sealing arrangement, as the pressure exerted by the set screws 24 will be pressing both of the fluid inlet ports 14a1′ and 50′ into corresponding ports in the hub 12. Nevertheless, a fluidic port could be placed on the side of the chip 14 at the expense of manufacturability of the hub 12 and compromised sealing (though chip geometry and appropriate gaskets may help to minimize any possible leaking at that port).

One additional consideration is that with the chip 14 designs as shown and described herein, these designs are essentially indicating the core (42) and shell (50) are going to in a planar arrangement when they go out of the exit. It is possible that one may want to add design features at 50a2′ to make the core fluid stream slightly smaller in diameter so that it can be better surrounded by the shell fluid in 360 degrees, forming a core-shell liquid jet. This can be done by adding small slope or lifting pieces near the outlet of 50a2′ (on the back side of 14c2′), or by changing the relative widths, lengths or other dimensions, in addition to angles of the two fluid paths.

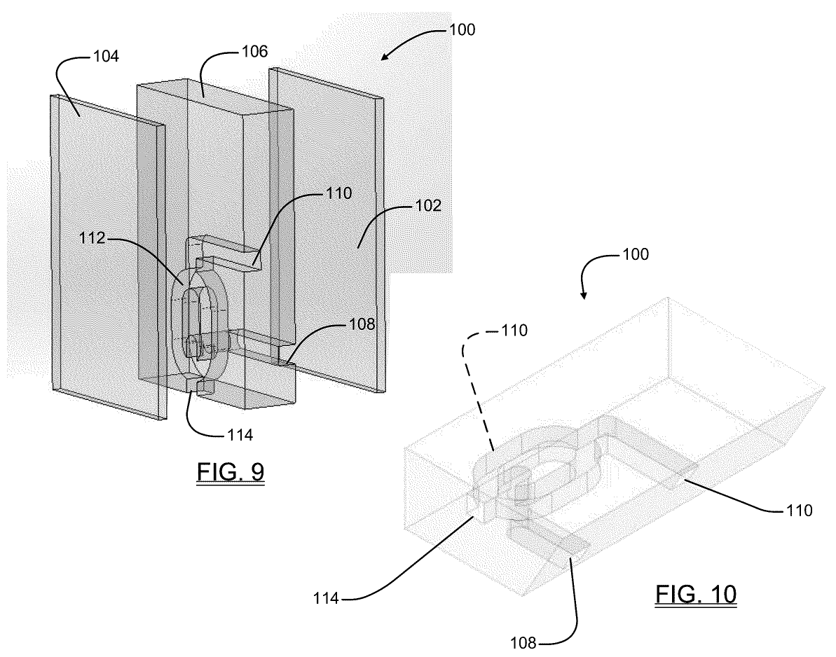

FIG. 9 shows another chip 100 embodiment which is suitable for manufacturing with hot embossing operation. In this construction the chip 100 also has a three piece design including panels 102, 104 and 106, but inlet 108, for the first fluid 38, and inlet 110 for the second fluid, are both formed in the center panel 106, as is an O-shaped flow path 112 and a fluid exit port 114. FIG. 10 shows a final construction of the chip 100 using a hot embossing operation. In addition, the features discussed in connection with FIG. 8 may also be added to the back side of panel 104, to basically force the core fluid away from the wall, to be better surrounded by shell fluid. This construction would also be compatible with injection molding processes (injection mold panel 106) and add flat capping layers 102/104 thereafter via suitable bonding methods as mentioned hereinabove.

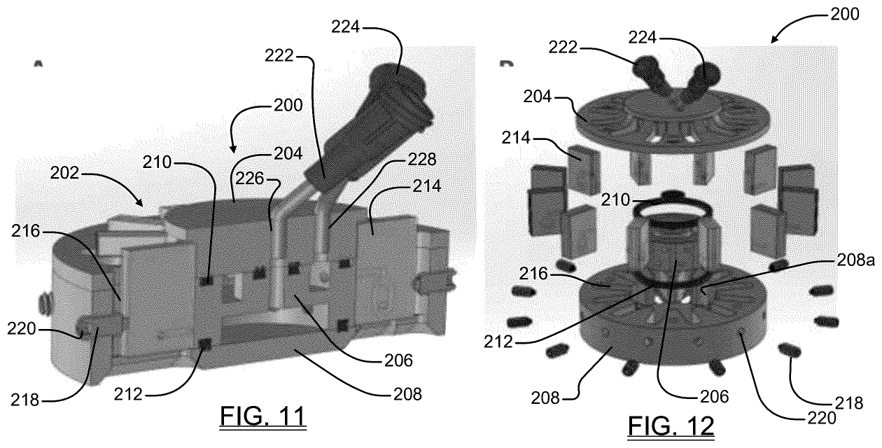

FIGS. 11 and 12 shows a multifluidic nozzle system 200 in accordance with another embodiment of the present disclosure. The system 200 in this example is of a multi-piece construction in which a hub 202 includes three distinct portions: an upper or cap portion 204, a central portion 206 and a lower portion 208. Gasket 210 helps to seal the mating surfaces between the upper portion 204 and the middle portion 206, while gasket 212 helps to seal the mating surfaces between the lower portion 208 and the middle portion 206. Fluidic control chips 214 are held in recesses 216 formed by the lower portion 208 and the middle portion 206. The middle portion 206 rests inside of a bore 208a (visible in FIG. 12) in the lower portion 208. The upper portion 204 is bolted or otherwise suitably secured to the lower portion 208 with the middle portion 206 sandwiched between the two. Set screws 218 (or other securing methods as described herein) are threadably engaged in threaded bores 220 to secure the chips 214 in their respective recesses 216. The fluid flows within the hub 202 may be the same as described in connection with hub 12. Syringes or fluid conduits 222 and 224 may be coupled to the upper portion 204 to supply streams of fluid into ports 226 and 228, respectively. The multi-piece construction of the 202 enables it to be manufactured using conventional molding and/or machining processes. The multi-piece design may also ease cleaning of the system 10 or 200 and/or facilitating making minor internal modifications, such as adding flow restrictions within the system 200. The bottom portion 208 and the center portion 206 can also be treated hydrophilic or hydrophobic components to provide even better flow properties. It will also be appreciated that the nozzle system 200, in some embodiments, may include the lower plate 34 shown in FIGS. 4 and 5.

A central feature of the systems 10 and 200 described herein is their modularity and scalability. The modular design enables the systems 10 and 200 to be expanded to 100s or more parallel units. Each of the systems 10 and 200 may also be scaled to include two or more concentric rings of chips 14 with 4, 6, 8 or more separate reservoirs disposed at different depths within the hub 12 or 202. The diameter and thickness of the hub 12 or 202 can be dimensioned as needed to accommodate desired number of chips 14. The chips 14 or the hub 12/202 can be manufactured or fitted with flow restricting elements to further tailor the flow of each of the fluids 38 and 40 to each chip 14 to create either a stream or double emulsions with specific diameters. And while the hub 12 has been shown as being circular, other designs could be readily implemented as well. For example, a square, rectangular, triangular, etc., hub could be formed. If a square or rectangular hub is used, then the X/Y grid of chips 14 may be arranged in the hub. Thus, the shape and thickness (i.e., depth) of the hub may be tailored as needed to provide the desired number of chips 14 and the desired number of internal fluid reservoirs.

In some embodiments the hub 12/202 may be constructed to provide a combination of fluid streams and double emulsions having different dimensions. In some embodiments the hub 12/202 may even be mounted to a rotational component, such an output shaft of a stepper motor, so that the entire hub 12/202 is rotated incrementally and precisely at different times to apply streams or double emulsions as needed to different areas depending on the part(s) being manufactured. In some embodiments the hub 12/202 does not need to be rotating but could be moved in one or more of the X, Y and/or Z axes, with rotating or not rotating. Also, the entire hub 12/202 may be operated by facing upwardly or at any other angle, and therefore does not need to be facing downwardly.

With the systems 10 and 200, an external air pressure source also be used to regulate droplet breaking, leading to monodisperse droplet creation. Alternatively and/or in addition to the use of air pressure, the systems 10 and/or 200 can also be coupled with a mechanical vibration source such as vibrating piezo actuator (not shown), which can also lead to controlled droplet breakage. There are also many other ways of droplet breakage such as mechanical shutter and liquid pulsing. Note that fine parameter tuning of the droplet breaking mechanisms are likely to be most always necessary to ensure a consistent creation of uniform droplets.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A modular, multi-fluidic, multi-nozzle system comprising:
a hub having:
a first internal fluid reservoir for holding a first fluid;
a second internal fluid reservoir for holding a second fluid;
a recess in flow communication with each of the first and second internal fluid reservoirs;
a fluid droplet generation chip removably secured in the recess and including first and second flow paths in communication with the first and second internal fluid reservoirs, and an opening forming an ejection port;
the fluid droplet generation chip configured to receive a stream of the first fluid and a stream of the second fluid, and to release the two streams simultaneously through the ejection port in a manner by which double emulsion fluid droplets are created in which a quantity of the first fluid is fully encapsulated within a quantity of the second fluid.

2. The system of claim 1, further comprising:
a plurality of the recesses arranged circumferentially about the hub and in communication with the first and second internal fluid reservoirs; and
a corresponding plurality of the fluid droplet generation chips disposed in the plurality of recesses, for receiving a plurality of the first streams and a plurality of the second streams, and creating a plurality of streams of double emulsions from the plurality of fluid droplet generation chips.

3. The system of claim 1, further comprising:
the hub having a threaded set screw hole; and
a set screw threadably engaged within the set screw hole for engaging a side edge of the fluid droplet generating chip and securing the fluid droplet generating chip within the recess.

4. The system of claim 1, wherein the fluid droplet generating chip includes a first flow path for channeling the first fluid to the ejection port, and a second O-shaped flow path for channeling the second fluid to the ejection port such that the second fluid encapsulates the first fluid as the first and second fluids are released through the ejection port.

5. The system of claim 1, wherein the hub further includes:
a first port in communication with a first external fluid source for enabling filling of the first reservoir with the first fluid; and
a second port in communication with a second external fluid source for enabling filling of the second fluid reservoir.

6. The system of claim 2, further comprising a lower plate secured to a lower surface of the hub, the lower plate including a plurality of openings in communication with the ejection ports of the fluid droplet generation chips to further help create the double emulsion droplets.

7. The system of claim 1, wherein the hub comprises a single piece component.

8. The system of claim 1, wherein the hub comprises a multi-piece component having an upper portion, a lower portion and a central portion sandwiched between the upper portion and the lower portion.

9. The system of claim 8, further comprising a first gasket disposed between the lower portion and the central portion, and a second gasket disposed between the upper portion and the central portion.

10. The system of claim 2, wherein the plurality of recesses and the plurality of fluid droplet generation chips are arranged radially about a circumference of the hub and equidistantly spaced from one another.

11. The system of claim 1, wherein the droplet generation chip comprises a multi-panel construction having a central panel portion and first and second outer panel portions sandwiching the central panel therebetween.

12. The system of claim 1, wherein the droplet generation chip includes a first inlet on a planar sidewall portion for receiving the first fluid, and a second inlet on an edge wall for receiving the second fluid.

13. The system of claim 1, wherein the droplet generation chip includes a first inlet on an edge wall for receiving the first fluid, and a second inlet on the edge wall for receiving the second fluid.

14. A modular, multi-fluidic, multi-nozzle system comprising:
a hub having:
a first port for admitting a first fluid from a first external fluid source into the hub;
a second port for admitting a second fluid from a second external fluid source into the hub;
a first internal fluid reservoir in communication with the first port for receiving and holding a first quantity of the first fluid; and
a second internal fluid reservoir in communication with the second port for receiving and holding a first quantity of the second fluid;
a plurality of recesses arranged radially about an axial center of the circular hub, and in flow communication with each of the first and second internal fluid reservoirs;
a plurality of fluid droplet generation chips each being removably secured in the recess, and each including first and second flow paths in communication with the first and second internal fluid reservoirs, and each having an opening at a lower end thereof forming an ejection port;
the fluid droplet generation chips each being configured to receive a stream of the first fluid and a stream of the second fluid, and to release the two streams simultaneously through the ejection port in a manner by which double emulsion fluid droplets are created in which a second quantity of the first fluid is fully encapsulated within a second quantity of the second fluid.

15. The system of claim 14, wherein the first reservoir is disposed elevationally below the first reservoir within the hub.

16. The system of claim 14, wherein the plurality of fluid droplet generation chips comprise a multi-panel construction including a first outer panel, a central panel and a second outer panel, and wherein the central panel is sandwiched between the first outer panel and the second outer panel.

17. The system of claim 14, wherein each one of said plurality of fluid droplet generation chips includes:
a first fluid receiving port on a sidewall portion for receiving the first fluid; and
a second fluid receiving port on an edge wall portion for receiving the second fluid.

18. The system of claim 14, wherein each one of said plurality of fluid droplet generation chips includes:
a first fluid receiving portion on an edge wall portion for receiving the first fluid; and
a second fluid receiving portion on the edge wall portion for receiving the second fluid.

19. The system of claim 14, further comprising a plate secured to a lower side of the hub, the plate including a plurality of openings aligned with the ejection ports for assisting in forming the double emulsion droplets.

20. A method for generating double emulsion droplets, comprising:
providing a hub;
using a first port formed on the hub for admitting a first fluid from a first external fluid source into the hub;
using a second port formed on the circular hub for admitting a second fluid from a second external fluid source into the hub;
using a first internal fluid reservoir within the hub and in communication with the first port for receiving and holding a first quantity of the first fluid;
using a second internal fluid reservoir within the hub and in communication with the second port for receiving and holding a first quantity of the second fluid;
using a plurality of recesses arranged radially about an axial center of the circular hub, and in flow communication with each of the first and second internal fluid reservoirs, to receive a corresponding plurality of fluid droplet generation chips, each said fluid droplet generating chip being removably secured in the recess, and each including first and second flow paths in communication with the first and second internal fluid reservoirs, and each having an opening at a lower end thereof forming an ejection port;
using the fluid droplet generation chips to each receive a stream of the first fluid and a stream of the second fluid, and to release the two streams simultaneously through the ejection port in a manner by which a simultaneous parallel plurality of double emulsion fluid droplet streams are created in which a second quantity of the first fluid is fully encapsulated within a second quantity of the second fluid to form each said double emulsion droplet.
